(19) United States
(12) Patent Application Publication
(10) Pub. No.: US 2026/0172573 A1
(43) Pub. Date: Jun. 18, 2026

(54) ENCODING DEVICE, DECODING DEVICE, AND NON-TRANSITORY MACHINE-READABLE MEDIUM FOR ENCODING/DECODING VIDEO DATA

(71) Applicant: SHARP KABUSHIKI KAISHA, Sakai City (JP)

(72) Inventors: KAI-WEN LIANG, New Taipei City (TW); CHIH-YU TENG, New Taipei City (TW); YU-CHIAO YANG, New Taipei City (TW)

(21) Appl. No.: 19/423,052

(22) Filed: Dec. 17, 2025

Related U.S. Application Data
(60) Provisional application No. 63/735,049, filed on Dec. 17, 2024.

(51) Int. Cl. H04N 19/149; H04N 19/105; H04N 19/11; H04N 19/176

(52) U.S. Cl. CPC H04N 19/149; H04N 19/105; H04N 19/11; H04N 19/176

(57) ABSTRACT

An electronic device for decoding/encoding video data is provided. The electronic device receives the video data and determines a block unit from an image frame retrieved from the video data. The electronic device determines a Histogram of Occurrence (HoO) for the block unit by determining first reference block(s) based on first block vector(s) of first neighboring block(s) of the block unit, determining first intra prediction mode(s) based on the first reference block(s), and constructing the HoO based on the first intra prediction mode(s). The electronic device further determines a block prediction for the block unit based on the HoO, and reconstructs the block unit based on the block prediction. In addition, a non-transitory machine-readable medium for decoding/encoding video data is also provided.

### CROSS-REFERENCE TO RELATED APPLICATION(S)

The present disclosure claims the benefit of and priority to U.S. Provisional Patent Application Ser. No. 63/735,049, filed on Dec. 17, 2024, entitled “BLOCK VECTOR GUIDED BASED OBIC HISTOGRAM DERIVATION,” the content of which is hereby incorporated herein fully by reference in its entirety into the present disclosure for all purposes.

### FIELD

The present disclosure is generally related to video coding and, more specifically, to techniques for utilizing block vector information into occurrence-based intra coding to enhance block unit reconstruction in video decoding.

### BACKGROUND

Video coding has become essential for efficient storage and transmission of digital media, enabling applications from streaming services to high-definition broadcasting. Standards like H.264/AVC, HEVC, and VVC have evolved to compress video data by exploiting spatial and temporal redundancies, dividing frames into blocks for prediction, transformation, quantization, and entropy coding. Intra prediction, a key component, generates predictions within the same frame using neighboring reconstructed samples, reducing data sent to the decoder. Common intra modes include directional modes (e.g., angular modes) simulating edges at various angles, non-directional modes (e.g., Planar mode), and advanced tools such as most probable modes (MPMs) derived from adjacent blocks to minimize signaling overhead.

As video resolutions increase, intra prediction faces demands for higher accuracy with lower computational overhead. Template-based approaches have emerged, where modes are derived by evaluating costs on reconstructed template regions adjacent to the current block, allowing decoder-side mode selection without explicit signaling. Meanwhile, matrix-based modes apply weighted combinations of reference samples via predefined matrices, offering position-dependent predictions that can outperform traditional modes for certain block geometries.

However, limitations in balancing complexity and performance may be encountered. For instance, conventional mode derivation schemes (e.g., MPMs) are typically restricted to using intra modes from immediately adjacent neighboring blocks, which may not capture optimal correlations in cases of repetitive patterns or displaced content within the frame. Specifically, the conventional schemes often overlook information indicated by block vectors (BVs) of neighboring blocks, failing to utilize the statistical distribution of modes (e.g., histograms) from the referenced non-adjacent areas, leading to reduced prediction accuracy for certain block units. These challenges highlight the need for refined harmonization strategies to maintain coding gains without exacerbating resource demands in modern video ecosystems.

### SUMMARY

The present disclosure is directed to a device and method for enhancing block unit prediction and reconstruction, and improving accuracy by utilizing block vector information into occurrence-based intra coding.

According to a first aspect of the present disclosure, an electronic device for decoding video data is provided. The electronic device includes: at least one processor; and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine a Histogram of Occurrences (HoO) for the block unit, where determining the HoO includes: determining one or more first reference blocks based on one or more first block vectors of one or more first neighboring blocks of the block unit, determining one or more first intra prediction modes based on the one or more first reference blocks, and constructing the HoO based on the one or more first intra prediction modes; determine a block prediction for the block unit based on the HoO; and reconstruct the block unit based on the block prediction.

In an implementation of the first aspect, determining the HoO further includes: determining an intra prediction mode of a first reference block among the one or more first reference blocks; and updating the HoO by accumulating a weighted occurrence of the intra prediction mode. The intra prediction mode of the first reference block corresponds to a weight, and the weight is determined based on an area of the first reference block.

In another implementation of the first aspect, determining the HoO further includes: determining an intra prediction mode of a first reference block among the one or more first reference blocks; and updating the HoO by accumulating a weighted occurrence of the intra prediction mode. The intra prediction mode of the first reference block corresponds to a weight, and the weight is determined based on a distance between the block unit and the first reference block.

In another implementation of the first aspect, determining the one or more first reference blocks based on the one or more first block vectors of the one or more first neighboring blocks of the block unit includes: determining one or more second reference blocks indicated by the one or more first block vectors; determining one or more second block vectors of the one or more second reference blocks; and determining the one or more first reference blocks based on the one or more second block vectors.

In another implementation of the first aspect, determining the one or more first intra prediction modes based on the one or more first reference blocks includes: determining that a first reference block, among the one or more first reference blocks, is coded based on a Virtual Intra Prediction Mode (VIPM); and applying a Decoded-side Intra Prediction Mode Derivation (DIMD) on the first reference block to derive at least one second intra prediction mode, among the one or more first intra prediction modes.

In another implementation of the first aspect, the one or more first intra prediction modes include multiple first intra prediction modes. Determining the one or more first intra prediction modes based on the one or more first reference blocks includes: determining multiple selected first reference blocks, among the one or more first reference blocks, based on multiple distances from the block unit to the multiple selected first reference blocks; and determining the multiple first intra prediction modes of the multiple selected first reference blocks. A total number of the multiple first intra prediction modes is equal to a predetermined number.

In another implementation of the first aspect, determining the HoO further includes: determining a temporal candidate associated with the block unit, the temporal candidate being collocated with the block unit; determining at least one temporal-shifted candidate, that is associated with the block unit, based on at least one motion vector of at least one second neighboring block of the block unit; determining multiple third intra prediction modes based on the temporal candidate and the at least one temporal-shifted candidate; and constructing the HoO further based on the multiple third intra prediction modes.

In another implementation of the first aspect, determining the HoO further includes: determining whether at least one candidate, among the temporal candidate and the at least one temporal-shifted candidate, corresponds to at least one third block vector; and when the at least one candidate is determined to correspond to the at least one third block vector: determining at least one third reference block based on the at least one third block vector, determining one or more fourth intra prediction modes based on the at least one third reference block, and constructing the HoO further based on the one or more fourth intra prediction modes.

In another implementation of the first aspect, determining the block prediction for the block unit based on the HoO includes: selecting, from the HoO, multiple intra prediction mode having highest occurrences; determining multiple directional predictions based on the selected multiple intra prediction modes; determining a non-directional prediction based on at least one of a planar predictor or one or more block vector-based predictors; determining multiple blending weights for the multiple directional predictions based on multiple occurrence amplitudes of the selected multiple intra prediction mode; and determining the block prediction by weighted blending the multiple directional predictions and the non-directional prediction based on the multiple blending weights.

In another implementation of the first aspect, the one or more first reference blocks include multiple first reference blocks. Determining the block prediction for the block unit based on the HoO further includes: determining multiple template costs for the multiple first reference blocks, where determining the multiple template costs includes: for each of the multiple first reference blocks, determining one of the multiple template costs based on a first reconstructed template of the block unit and a second reconstructed template of a corresponding first reference block; selecting multiple block vector-based predictors corresponding to the multiple first reference blocks based on the multiple template costs; and determining the non-directional prediction by weighted blending the selected multiple block vector-based predictors, where a weight for each of the selected multiple block vector-based predictors is determined based on the multiple template costs.

According to a second aspect of the present disclosure, an electronic device for encoding video data is provided. The electronic device includes: at least one processor; and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine a HoO for the block unit, where determining the HoO includes: determining one or more first reference blocks based on one or more first block vectors of one or more first neighboring blocks of the block unit, determining one or more first intra prediction modes based on the one or more first reference blocks, and constructing the HoO based on the one or more first intra prediction modes; determine a block prediction for the block unit based on the HoO; and reconstruct the block unit based on the block prediction.

In an implementation of the second aspect, determining the HoO further includes: determining an intra prediction mode of a first reference block among the one or more first reference blocks; and updating the HoO by accumulating a weighted occurrence of the intra prediction mode. The intra prediction mode of thee first reference block corresponds to a weight, and the weight is determined based on at least one of an area of the first reference block, or a distance between the block unit and the first reference block.

In another implementation of the second aspect, determining the one or more first reference blocks based on the one or more first block vectors of the one or more first neighboring blocks of the block unit includes: determining one or more second reference blocks indicated by the one or more first block vectors; determining one or more second block vectors of the one or more second reference blocks; and determining the one or more first reference blocks based on the one or more second block vectors.

In another implementation of the second aspect, determining the one or more first intra prediction modes based on the one or more first reference blocks includes: determining that a first reference block, among the one or more first reference blocks, is coded based on a VIPM; and applying a DIMD on the first reference block to derive at least one second intra prediction mode, among the one or more first intra prediction modes.

In another implementation of the second aspect, the one or more first intra prediction modes include multiple first intra prediction modes. Determining the one or more first intra prediction modes based on the one or more first reference blocks includes: determining multiple selected first reference blocks, among the one or more first reference blocks, based on multiple distances from the block unit to the multiple selected first reference blocks; and determining the multiple first intra prediction modes of the multiple selected first reference blocks. A total number of the multiple first intra prediction modes is equal to a predetermined number.

In another implementation of the second aspect, determining the HoO further includes: determining a temporal candidate associated with the block unit, the temporal candidate being collocated with the block unit; determining at least one temporal-shifted candidate, that is associated with the block unit, based on at least one motion vector of at least one second neighboring block of the block unit; determining multiple third intra prediction modes based on the temporal candidate and the at least one temporal-shifted candidate; and constructing the HoO further based on the multiple third intra prediction modes.

In another implementation of the second aspect, determining the HoO further includes: determining whether at least one candidate, among the temporal candidate and the at least one temporal-shifted candidate, corresponds to at least one third block vector; and when the at least one candidate is determined to correspond to the at least one third block vector: determining at least one third reference block based on the at least one third block vector, determining one or more fourth intra prediction modes based on the at least one third reference block, and constructing the HoO further based on the one or more fourth intra prediction modes.

In another implementation of the second aspect, determining the block prediction for the block unit based on the HoO includes: selecting, from the HoO, multiple intra prediction mode having highest occurrences; determining multiple directional predictions based on the selected multiple intra prediction modes; determining a non-directional prediction based on at least one of a planar predictor or one or more block vector-based predictors; determining multiple blending weights for the multiple directional predictions based on multiple occurrence amplitudes of the selected multiple intra prediction mode; and determining the block prediction by weighted blending the multiple directional predictions and the non-directional prediction based on the multiple blending weights.

In another implementation of the second aspect, the one or more first reference blocks include multiple first reference blocks. Determining the block prediction for the block unit based on the HoO further includes: determining multiple template costs for the multiple first reference blocks, where determining the multiple template costs includes: for each of the multiple first reference blocks, determining one of the multiple template costs based on a first reconstructed template of the block unit and a second reconstructed template of the corresponding first reference block; selecting multiple block vector-based predictors corresponding to the multiple first reference blocks based on the multiple template costs; and determining the non-directional prediction by weighted blending the multiple selected multiple block vector-based predictors, where a weight for each of the multiple selected multiple block vector-based predictors is determined based on the multiple template costs.

According to a third aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit from an image frame retrieved from the video data; determine a HoO for the block unit, where determining the HoO includes: determining one or more first reference blocks based on one or more first block vectors of one or more first neighboring blocks of the block unit, determining one or more first intra prediction modes based on the one or more first reference blocks, and constructing the HoO based on the one or more first intra prediction modes; determining a block prediction for the block unit based on the HoO; and reconstructing the block unit based on the block prediction.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of the present disclosure.

FIG. 2 is a block diagram illustrating a decoder module of the second electronic device illustrated in FIG. 1, in accordance with one or more example implementations of the present disclosure.

FIG. 3 is a flowchart illustrating a method/process for decoding and/or encoding video data by an electronic device, in accordance with one or more example implementations of the present disclosure.

FIG. 4 is a diagram illustrating adjacent blocks of a block unit, in accordance with one or more example implementations of the present disclosure.

FIG. 5 is a diagram illustrating adjacent and non-adjacent blocks of a block unit, in accordance with one or more example implementations of the present disclosure.

FIG. 6 is a diagram illustrating block vector-guided reference block(s), in accordance with one or more example implementations of this disclosure.

FIG. 7 is a flowchart illustrating a process for determining a Histogram of Occurrence (HoO) for the block unit, in accordance with one or more example implementations of this disclosure.

FIG. 8 is a flowchart illustrating a process for determining a block prediction for the block unit based on the HoO, in accordance with one or more example implementations of this disclosure.

FIG. 9 is a block diagram illustrating an encoder module of the first electronic device illustrated in FIG. 1, in accordance with one or more example implementations of the present disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The present disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

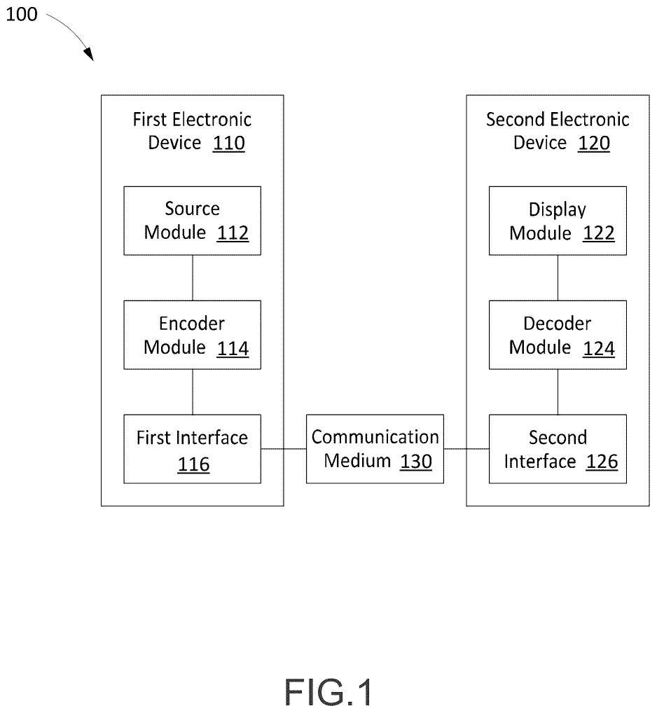

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000(CDMA 2000 ), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

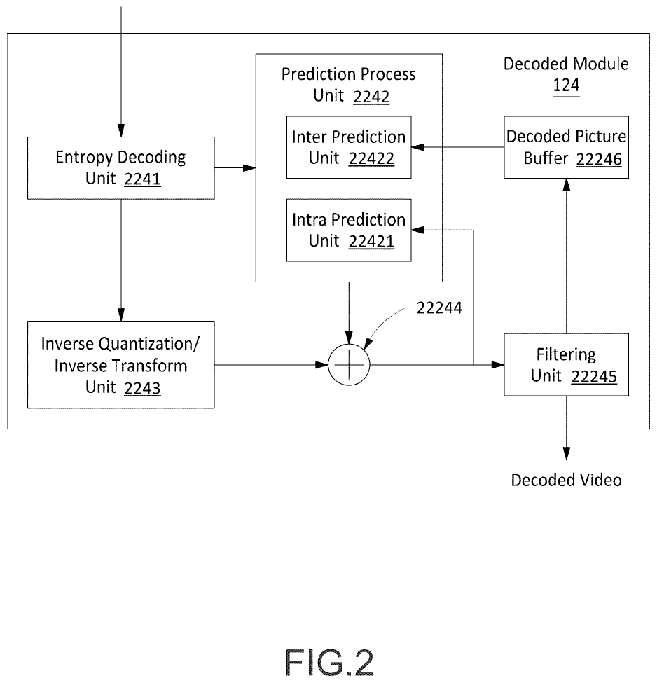

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit are reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block.

The motion vector may indicate a displacement of the current block unit within the current image block relative to a reference block unit within the reference image block. The reference block unit may be a block (e.g., in a reference frame) determined to closely match the current block unit.

The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block (e.g., residual samples of the block) to the predicted block (e.g., predicted samples of the block) provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (which are not explicitly illustrated for the brevity of description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

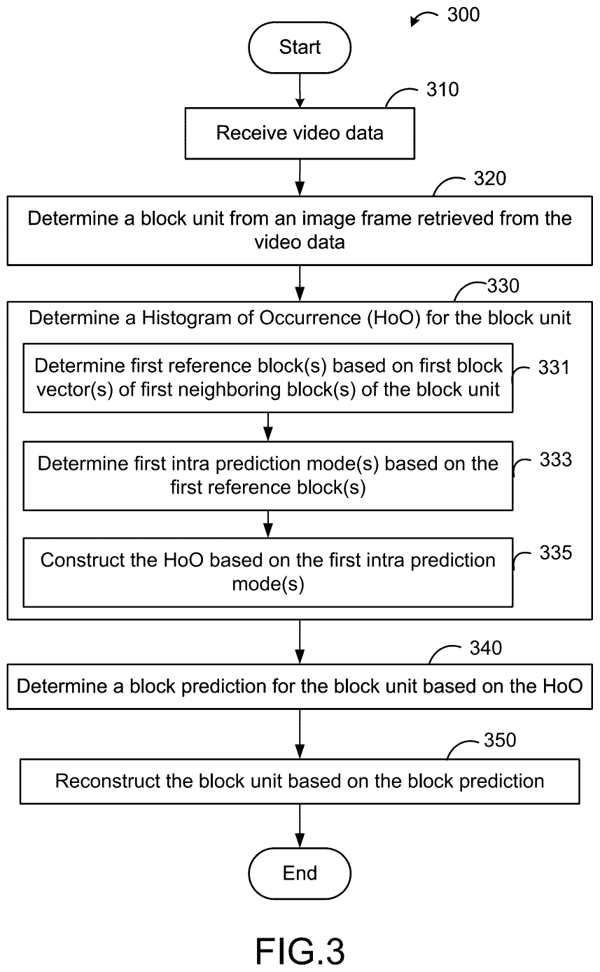

FIG. 3 is a flowchart illustrating a method/process 300 for decoding and/or encoding video data by an electronic device, in accordance with one or more example implementations of this disclosure. The method/process 300 is an example implementation, as there may be a variety of methods of decoding/encoding the video data.

The method/process 300 may be performed by an electronic device, such as the electronic device 110 or electronic device 120, using the configurations illustrated in FIGS. 1 and 2, where various elements of these figures may be referenced to describe the method/process 300. Each action illustrated in FIG. 3 may represent one or more processes, methods, or subroutines performed by an electronic device.

The order in which the actions appear in FIG. 3 is for illustration only and may not be construed to limit the scope of the present disclosure, thus may be different from what is illustrated. Additional actions may be added, or less actions may be utilized without departing from the scope of the present disclosure.

In action 310, the method/process 300 may start by receiving (e.g., by the decoder module 124/encoder module 114) the video data.

With reference to FIG. 1 and FIG. 2, the second electronic device 120 may receive the bitstream from an encoder, such as the first electronic device 110, or from other video providers, via the second interface 126. The second interface 126 may provide the bitstream to the decoder module 124.

For example, from the decoder's perspective, the video data received by the decoder module 124 may include a bitstream provided by the encoder module 114, which may include information of multiple image frames. For example, from the encoder's perspective, the video data received by the encoder module 114 may include one or more uncompressed image frames, which may represent the input video signal to be compressed.

The entropy decoding unit 2241 may decode the bitstream to determine multiple prediction indications and multiple partitioning indications for multiple video images. The decoder module 124 may then reconstruct the video images based on the prediction indications and the partitioning indications. The prediction indications and the partitioning indications may include multiple flags and multiple indices.

In action 320, the method/process 300 may determine (e.g., by the decoder module 124/encoder module 114), a block unit from an image frame retrieved from the video data.

With reference to FIG. 1 and FIG. 2, the decoder module 124 may determine or retrieve the image frames from the bitstream and may divide each image frame to determine the block units, according to the partition indications in the bitstream. For example, the decoder module 124 may divide the image frames to generate multiple CTUs and further divide one of the CTUs to determine the block units, according to the partition indications, using any video coding standard.

For example, from the decoder's perspective, the video data may include the bitstream from the encoder, and a block unit may be determined from an image frame according to the partitioning information (e.g., QT/MTT/SBT split flags) parsed from the bitstream. For example, from the encoder's perspective, the video data may include one or more uncompressed image frames, and the block unit may be determined (e.g., based on rate-distortion optimized partitioning decisions by evaluating possible QT, MTT, or other split structures) applied to the current CTU or CU being processed.

In some implementations, the block unit may be a current block. For example, the current block may include at least one of a coding unit, a prediction unit, a macroblock, a luma block, and a chroma block.

In action 330, the method/process 300 may determine (e.g., by the decoder module 124/encoder module 114) a Histogram of Occurrence (HoO) for the block unit. The HoO may, for example, collect intra prediction mode(s) (e.g., directional modes) and the (e.g., sample-wise) occurrence(s) of the collected intra prediction mode(s).

In some implementations, the intra prediction mode(s) may be collected from reference block(s) of the block unit. In some implementations, at least one of the reference block(s) may include neighboring block(s) of the block unit. In some implementations, at least one of the reference block(s) may be determined based on at least one block vector (BV) associated with the block unit (e.g., at least one block vector of at least one neighboring/reference block of the block unit). In some implementations, at least one of the reference block(s) may be located in a collocated frame of the image frame of the block unit.

In some implementations, the decoder module 124/encoder module 114 may collect the intra prediction mode(s) for determining/constructing the HoO based on one or more of the neighboring blocks of the block unit. For example, the neighboring block(s) may include one or more of the adjacent blocks. As another example, the neighboring block(s) may include one or more of the non-adjacent blocks. As another example, the neighboring block(s) may include one or more of the adjacent blocks and one or more of the non-adjacent blocks. In some implementations, the decoder module 124/encoder module 114 may determine the adjacent block(s) and the non-adjacent block(s) based on a predefined pattern.

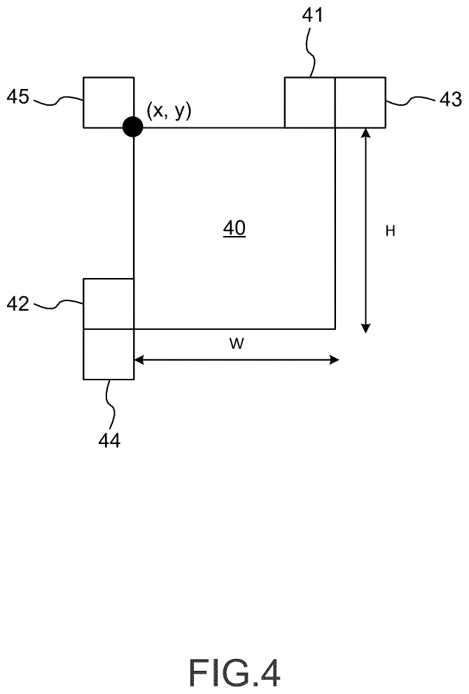

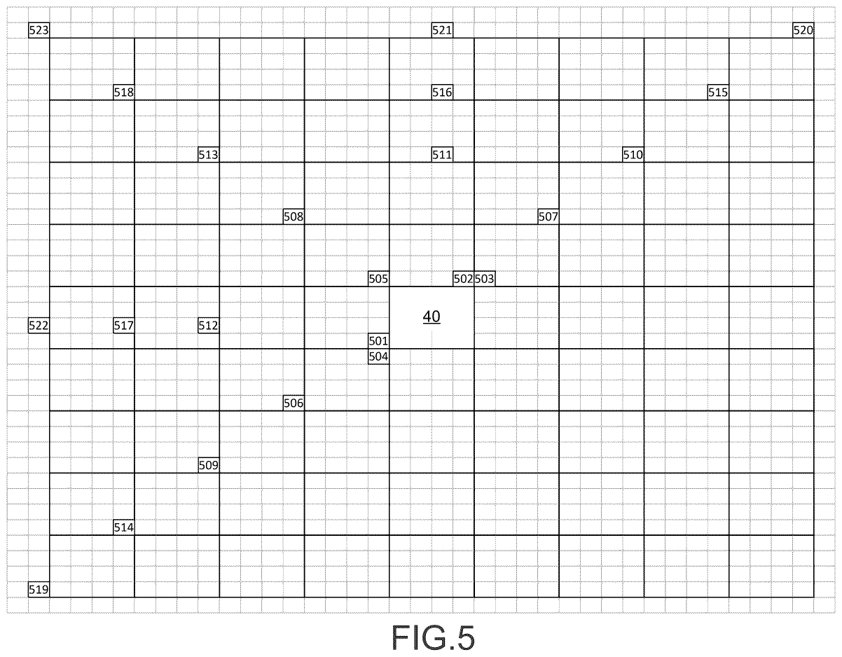

FIG. 4 is a diagram illustrating adjacent blocks of a block unit, in accordance with one or more example implementations of this disclosure. FIG. 5 is a diagram illustrating adjacent and non-adjacent blocks of the block unit, in accordance with one or more example implementations of this disclosure.

Referring to FIG. 4, adjacent blocks of the block unit 40 may include a top block 41, a left block 42, a top-right block 43, a bottom-left block 44, and a top-left block 45. The position of the top-left corner of the block unit 40 may be (x, y), the width of the block unit 40 may be W, and the height of the block unit 40 may be H, where W and H are positive integers. The top block 41 may be a block including a sample located at (x+W−1, y−1), the left block 42 may be a block including a sample located at (x−1, y+H−1), the top-right block 43 may be a block including a sample located at (x+W, y−1), the bottom-left block 44 may be a block including a sample located at (x−1, y+H), and the top-left block 45 may be a block including a sample located at (x−1, y−1).

Referring to FIG. 5, blocks 501 to 505 may be the adjacent blocks of the block unit 40, as described in FIG. 4. Blocks 506 to 523 may be the non-adjacent blocks of the block unit 40 (e.g., which may be the same as those defined for the inter merge mode). The distances between the non-adjacent (coded) blocks 506 to 523 and the block unit 40 may be determined based on the width and height of the block unit 40.

However, the definition of neighboring blocks (e.g., including adjacent blocks and/or non-adjacent blocks) of a block unit is not limited to what is described with reference to FIGS. 4 and 5. A person of ordinary skill in the art may adopt different definitions as needed, e.g., depending on the coding standard or implementation.

In some implementations, the occurrence of the intra prediction mode(s) in the HoO may be sample-wise. In other words, when an intra prediction mode is collected from a reference block, the HoO may be updated by accumulating a weighted occurrence of the intra prediction mode, and the corresponding weight may be determined based on the area of the reference block.

For example, a reference block, among the neighboring blocks of the block unit 40, may be coded based on an intra prediction mode M1, and the occurrence of the intra prediction mode M1 may be calculated based on the following equation:

$$H o O [ M 1 ] += uiWidth 1 \times uiHeight 1 ,$$

where uiWeight1 may represent the width of the reference block, and uiHeight1 may represent the height of the reference block.

For example, a reference block, among the neighboring blocks of the block unit 40, may be coded based on another intra prediction mode M2, and the occurrence of the intra prediction mode M2 may be calculated based on the following equation:

$$HoO [ M 2 ] += uiWidth 2 \times uiHeight 2 ,$$

where uiWeight2 may represent the width of the reference block, and uiHeight2 may represent the height of the reference block.

For example, a reference block, among the neighboring blocks of the block unit 40, may be coded based on more than one intra prediction modes M3 to M5, and the occurrences of all the used intra prediction modes M3 to M5 may be calculated based on the following equation:

$$H o O [ M 3 ] += u i W i dth 3 \times uiHeight 3 ;$$

$$HoO [ M 4 ] += u i W i dth 3 \times uiHeight 3 ;$$

$$HoO [ M 5 ] += u i W i dth 3 \times uiHeight 3 ,$$

where uiWeight3 may represent the width of the reference block, and uiHeight3 may represent the height of the reference block. It should be noted that the number of the intra prediction modes that are used may differ depending on the coding technique. For example, the Decoder-side Intra Mode Derivation (DIMD) may use up to 5 angular modes, the Template-based Intra Mode Derivation (TIMD) and the Spatial Geometric Partition Mode (SGPM) may use up to 2 modes and the Occurrence-Based Intra Coding (OBIC) may use up to 5 angular modes. All the intra prediction modes that are used may be accumulated for updating the HoO.

Deduced by analogy, the decoder module 124/encoder module 114 may determine the HoO, at least, based on the intra prediction mode(s) for coding the neighboring block(s) of the block unit.

In some implementations, the method for updating the HoO used in the OBIC, proposed in JVET-AH0076, may be adopted in the present disclosure.

In some implementations, the decoder module 124/encoder module 114 may collect the intra prediction mode(s) for constructing the HoO based on one or more reference blocks (e.g., also referred to as one or more first reference blocks in the present disclosure) associated with the block units, where the one or more first reference blocks may be determined based on one or more block vectors (e.g., also referred to as one or more first block vectors in the present disclosure) of the neighboring block(s) of the block unit.

Referring back to FIG. 3, in action 330, the process 300 may determine the HoO for the block unit. In some implementations, to determine the HoO, the process 300 may perform actions 331, 333, and 335, as shown in FIG. 3. In action 331, the method/process 300 may determine one or more first reference blocks based on one or more first block vectors of one or more first neighboring blocks of the block unit.

In some implementations, one or more neighboring blocks (e.g., the one or more first neighboring blocks) of the block unit may have block vector information. For example, the one or more first neighboring blocks of the block unit may be coded using an intra block copy (IBC) mechanism or an intra template matching prediction (IntraTMP) method, and the one or more first block vectors may be determined from the one or more first neighboring blocks. The reference block(s) which are derived based on block vector information may be referred to as BV-guided reference block(s) in the present disclosure. Therefore, the first reference block(s) may be BV-guided reference block(s).

In some implementations, the one or more first reference blocks may include one or more first-chain/level (e.g., single-hop) BV-guided reference blocks. One or more of the first block vector(s) may indicate (e.g., point to) the one or more first-chain/level BV-guided reference blocks.

In some implementations, the one or more first reference blocks may include one or more multi-chain/level (e.g., multi-hop) BV-guided reference blocks. In some implementations, the decoder module 124/encoder module 114 may determine one or more second reference blocks indicated by the one or more first block vectors, where the one or more second reference blocks may have block vector information. The decoder module 124/encoder module 114 may further determine one or more second block vectors of the one or more second reference blocks, and the one or more multi-chain/level BV-guided reference blocks may be determined based on the one or more second block vectors.

In some implementations, a second reference block derived from a first block vector of a neighboring block of the block unit may possess valid block vector information (e.g., the second reference block may be coded by the IBC mechanism, the IntraTMP method, or any other mode that generates an explicit or derivable block vector). In such a case, the decoder module 124/encoder module 114 may recursively follow the block vector chain by obtaining one or more second block vectors from the one or more second reference blocks and using each second block vector to locate a subsequent reference block. The recursive process may be repeated for multiple levels (e.g., two levels, three levels, four levels, or more) until a predetermined maximum level count is reached, no further valid block vector is available, or another termination condition is satisfied. Accordingly, the one or more first reference blocks may be reached after n recursive steps (n≥2).

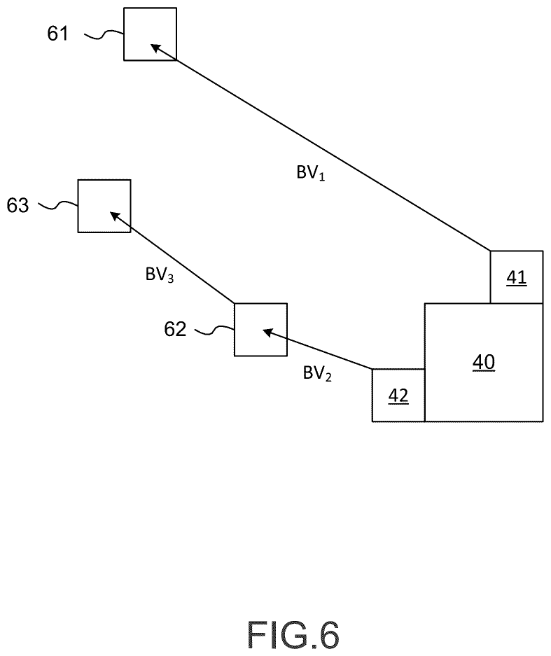

FIG. 6 is a diagram illustrating BV-guided reference block(s), in accordance with one or more example implementations of this disclosure.

Referring to FIG. 6, in some implementations, the block unit 40 may have a first neighboring block 41, which may be coded, for example, using either one of the IBC or IntraTMP. The first neighboring block 41 may be associated with (e.g., predicted based on) a first block vector BV₁. In other words, the first block vector BV₁ may be determined from the first neighboring block 41 of the block unit 40. The first block vector BV₁ may indicate a first reference block 61, which is located within the same image frame as the block unit 40. The first reference block 61 may also be referred to as a first-chain/level BV-guided reference block, which is associated with the block unit 40.

Referring to FIG. 6, in some implementations, the block unit 40 may have a first neighboring block 42, which may be coded by the IBC or IntraTMP. The first neighboring block 42 may be associated with (e.g., predicted based on) a first block vector BV₂. In other words, the first block vector BV₂ may be determined from the first neighboring block 42 of the block unit 40. The first block vector BV₂ may indicate a second reference block 62, which is located within the same image frame as the block unit 40. The second reference block 62 may be coded by the IBC or IntraTMP, and associated with a second block vector BV₃. The second block vector BV₃ may indicate a first reference block 63, which is located within the same image frame as the block unit 40. The first reference block 63 may also be referred to as a multi-chain/level (e.g., two-chain/level) BV-guided reference block, which is associated with the block unit 40.

Referring back to FIG. 3, in action 333, the method/process 300 may determine one or more first intra prediction modes based on the one or more first reference blocks. In action 335, the method/process 300 may construct the HoO based on the one or more first intra prediction modes.

In some implementations, the occurrence of the intra prediction mode(s) in the HoO may be sample-wise. The decoder module 124/encoder module 114 may determine an intra prediction mode of a first reference block among the one or more first reference blocks, and update the HoO by accumulating a weighted occurrence of the intra prediction mode, and the corresponding weight may be determined based on the area of the first reference block.

For example, a first reference block, among the one or more first reference blocks determined in action 331, may be coded based on an intra prediction mode M6, and the occurrence of the intra prediction mode M6 may be calculated based on the following equation:

$$HoO [ M 6 ] += u i W idth 4 \times uiHeight 4 ,$$

where uiWeight4 may represent the width of the first reference block, and uiHeight4 may represent the height of the first reference block.

For example, a first reference block, among the one or more first reference blocks determined in action 331, may be coded based on another intra prediction mode M7, and the occurrence of the intra prediction mode M7 may be calculated based on the following equation:

$$HoO [ M 7 ] += u i W idth 5 \times uiHeight 5 ,$$

where uiWeight5 may represent the width of the first reference block, and uiHeight5 may represent the height of the first reference block.

For example, a first reference block, among the one or more first reference blocks determined in action 331, may be coded based on more than one intra prediction modes M8 to M10, and the occurrences of all the used intra prediction modes M8 to M10 may be calculated based on the following equation:

$$HoO [ M 8 ] += u i W idth 6 \times uiHeight 6 ;$$

$$HoO [ M 9 ] += u i W idth 6 \times uiHeight 6 ;$$

$$HoO [ M 10 ] += u i W idth 6 \times uiHeight 6 ,$$

where uiWeight6 may represent the width of the first reference block, and uiHeight6 may represent the height of the first reference block. It should be noted that the number of the intra prediction modes that are used may differ depending on the coding technique. For example, the DIMD may use up to 5 angular modes, the TIMD and the SGPM may use up to 2 modes, and the OBIC may use up to 5 angular modes. All the intra prediction modes that are used may be accumulated for updating the HoO.

Deduced by analogy, the decoder module 124/encoder module 114 may determine the HoO at least based on the intra prediction mode(s) based on the one or more first reference blocks which are derived based on block vectors.

In some implementations, the occurrence of the intra prediction mode(s) in the HoO may (further) dependent on (e.g., positively correlated to) the distance between the (e.g., first) reference block and the block unit. In some examples, the decoder module 124/encoder module 114 may determine an intra prediction mode of a first reference block among the one or more first reference blocks, and update the HoO by accumulating a weighted occurrence of the intra prediction mode, and the corresponding weight may be determined based on distance between the first reference block and the block unit (e.g., as well as the area of the first reference block).

For example, a first reference block, among the one or more first reference blocks determined in action 331, may be coded based on an intra prediction mode M6, and the occurrence of the intra prediction mode M6 may be calculated based on the following equation:

$$HoO [ M 6 ] += u i W idth 4 \times uiHeight 4 \times Weight 1 ,$$

where uiWeight4 may represent the width of the first reference block, uiHeight4 may represent the height of the first reference block, and Weight1 may be associated with (e.g., negatively correlated to) the length of the first block vector (e.g., or a vector sum of the block vector chain) for pointing to the first reference block.

For example, a first reference block, among the one or more first reference blocks determined in action 331, may be coded based on another intra prediction mode M7, and the occurrence of the intra prediction mode M7 may be calculated based on the following equation:

$$HoO [ M 7 ] += u i Width 5 \times uiHeight 5 \times Weight 2 ,$$

where uiWeight5 may represent the width of the first reference block, uiHeight5 may represent the height of the first reference block, and Weight2 may be associated with (e.g., negatively correlated to) the length of the first block vector (e.g., or a vector sum of the block vector chain) for pointing to the first reference block.

For example, a first reference block, among the one or more first reference blocks determined in action 331, may be coded based on more than one intra prediction modes M8 to M10, and the occurrences of all the used intra prediction modes M8 to M10 may be calculated based on the following equation:

$$HoO [ M 8 ] += u i Width 6 \times uiHeight 6 \times Weight 3 ;$$

$$HoO [ M 9 ] += u i Width 6 \times uiHeight 6 \times Weight 3 ;$$

$$HoO [ M 10 ] += u i Width 6 \times uiHeight 6 \times Weight 3 ,$$

where uiWeight6 may represent the width of the first reference block, uiHeight6 may represent the height of the first reference block, and Weight3 may be associated with (e.g., negatively correlated to) the length of the first block vector (e.g., or a vector sum of the block vector chain) for pointing to the first reference block.

In some implementations, a (e.g., first) reference block may be coded/predicted based on a Virtual Intra Prediction Mode (VIPM), such as an Extrapolation filter-based Intra Prediction (EIP) Emode, the IntraTMP mode, and/or a Matrix-based Intra Prediction (MIP) mode. In such a case, the decoder module 124/encoder module 114 may perform a DIMD process to determine at least one (e.g., up to 5) intra prediction mode (e.g., which may be also referred to as second intra prediction mode) for constructing the HoO. The decoder module 124/encoder module 114 may update the HoO based on the at least one second intra prediction mode (e.g., using the method described above). Therefore, the one or more first intra prediction modes determined in action 333 may include the at least one second intra prediction mode.

In some implementations, only a predetermined number of BV-guided reference block(s) may be used for constructing/determining the HoO. In some implementations, the selection of the BV-guided reference block(s) may be performed based on the distance from the block unit, and a total number of the selected BV-guided reference block(s) is equal to the predetermined number. For example, the BV-guided reference block(s) with the smallest BV lengths may be selected. Specifically, the decoder module 124/encoder module 114 may sort all the blocks indicated (pointed) by block vectors (e.g., and/or block chains) by distance from the block unit (e.g., length of block vector and/or length of vector sum of the block chain), and determine/select the blocks that corresponds to the smallest distances as the first reference blocks for constructing/determining the HoO. A total number of the selected blocks is equal to the predetermined number.

In some implementations, the adjacent block(s), the non-adjacent block(s) and the BV-guided reference block(s) may be all sorted by distance from the block unit, and only a predetermined number (e.g., N, where N may be a positive integer) of reference block(s) may be used for constructing/determining the HoO. In some implementations, based on the distances, a predefined number (e.g., M, where M may be a non-negative integer) of adjacent block(s) and non-adjacent block(s) may be selected, and the other (e.g., N-M reference blocks) may be selected from the BV-guided reference block(s).

In some implementations, a first maximum number n (e.g., where n may be a non-negative integer) may be set for adjacent block(s) and a second maximum number m (e.g., where m may be a non-negative integer) may be set for non-adjacent blocks. In such a case, up to the first maximum number of adjacent blocks may be selected, up to the second maximum number of non-adjacent blocks may be selected, and the other (e.g., at least N-n-m reference blocks, if N>n+m) may be selected from the BV-guided reference blocks.

In some implementations, motion vector information may be utilized for the construction of the HoO.

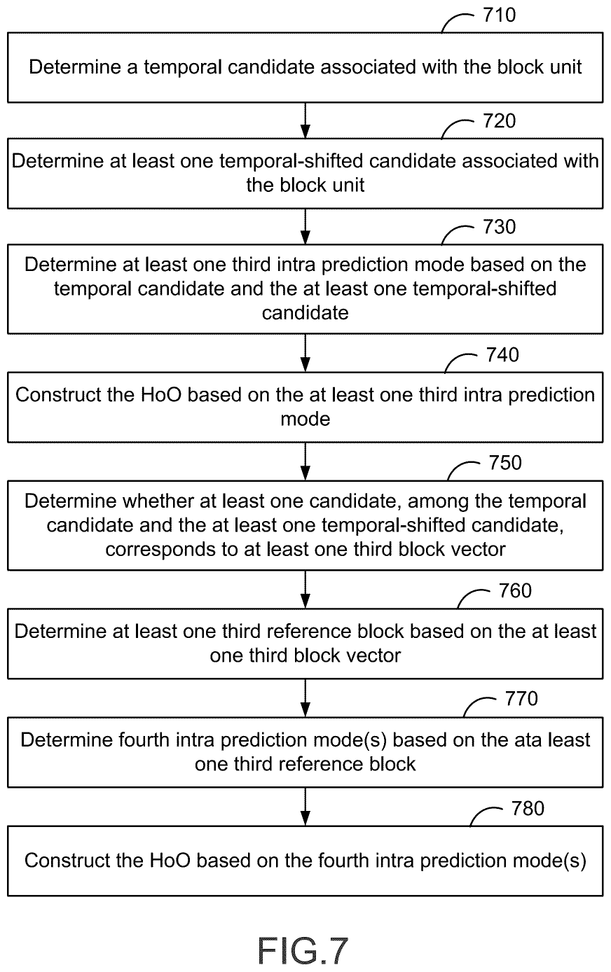

FIG. 7 is a flowchart illustrating a process for determining the HoO for the block unit, in accordance with one or more example implementations of this disclosure. Each action illustrated in FIG. 7 may represent one or more processes, methods, or subroutines performed by an electronic device. The order in which the actions appear in FIG. 7 is for illustration only and may not be construed to limit the scope of the present disclosure, thus may be different from what is illustrated. Additional actions may be added, or less actions may be utilized, without departing from the scope of the present disclosure.

Referring to FIGS. 3 and 7, action 330 may further include actions 710 to 780. In action 710, the decoder module 124/encoder module 114 may determine a temporal candidate associated with the block unit. In some implementations, the temporal candidate associated with the block unit may include a block located in a collocated frame and collocated with the block unit.

In some implementations, the decoder module 124/encoder module 114 may derive the temporal candidate(s) from one or more previously coded pictures (e.g., collocated frame(s)). In some implementations, the positions of the temporal candidates, as well as the order in which the temporal candidates are checked, may be identical to the candidate positions and checking order specified in the merge candidate list construction process of the applicable video coding standard (e.g., VVC, HEVC, etc.).

In action 720, the decoder module 124/encoder module 114 may determine at least one temporal-shifted candidate associated with the block unit. In some implementations, the temporal-shifted candidate(s) associated with the block unit may be determined based on motion vector information of at least one neighboring block of the block unit.

For example, when a neighboring block of the block unit possesses motion vector information, such as a motion vector, the decoder module 124/encoder module 114 may determine a temporal-shifted candidate by shifting the temporal candidate using the motion vector. Therefore, the temporal-shifted candidate may be located in the same collocated frame, as the temporal candidate. In some implementations, the temporal candidate and/or the temporal-shifted candidate may be considered to be reference block(s) for constructing the HoO.

In action 730, the decoder module 124/encoder module 114 may determine at least one intra prediction mode (e.g., also referred to as at least one third intra prediction mode in the present disclosure) based on the temporal candidate and the at least one temporal-shifted candidate. In action 740, the decoder module 124/encoder module 114 may construct the HoO based on the at least one third intra prediction mode.

In some implementation, the decoder module 124/encoder module 114 may determine the third intra prediction mode(s) used for coding the temporal candidate and the at least one temporal-shifted candidate, and update the HoO based on the third intra prediction mode(s) (e.g., using the method described above).

In action 750, the decoder module 124/encoder module 114 may determine whether at least one candidate, among the temporal candidate and the at least one temporal-shifted candidate, corresponds to at least one block vector (e.g., also referred to as at least one third block vector in the present disclosure). In some implementations, when a candidate, among the temporal candidate and the at least one temporal-shifted candidate, possesses block vector information, the block vector information may be utilized for the construction of the HoO. When the at least one candidate is determined to correspond to the at least one third block vector in action 750, the process 700 may proceed to action 760.

In action 760, the decoder module 124/encoder module 114 may determine at least one reference block (e.g., also referred to as at least one third reference block) based on the at least one third block vector. In some implementations, the at least one third block vector may indicate (e.g., point to) at least one third reference block from the at least one candidate in the collocated frame, and the at least one third reference block may be considered to be at least one BV-guided reference block.

In action 770, the decoder module 124/encoder module 114 may determine one or more intra prediction modes (e.g., also referred to as one or more fourth intra prediction modes in the present disclosure) based on the at least one third reference block. In action 780, the decoder module 124/encoder module 114 may construct the HoO based on the one or more fourth intra prediction modes.

In some implementation, the decoder module 124/encoder module 114 may determine the one or more fourth intra prediction mode(s) used for coding the at least third reference block, and update the HoO based on the one or more fourth intra prediction modes (e.g., using the method described above).

In some implementations, one or more (e.g., part or all) of the block vectors described above may be obtained from a block vector list (e.g., instead of being obtained from the neighboring block(s)).

Referring back to FIG. 3, when action 330 is completed, the HoO may be determined, such that it may include multiple intra prediction modes and the occurrence of each intra prediction mode. In some implementations, each intra prediction mode in the HoO may be a directional mode. In some implementations, each intra prediction mode in the HoO may be a direct current (DC) mode or one of 65 angular modes.

Referring back to FIG. 3, in action 340, the method/process 300 may determine a block prediction for the block unit based on the HoO.

In some implementations, based on the HoO, the decoder module 124/encoder module 114 may select and use the intra prediction mode(s) with highest occurrence(s) to determine the block prediction.

In some implementations, the decoder module 124/encoder module 114 may determine multiple first block predictions based on the HoO, determine a second block prediction, and weighted blending the first block predictions and the second block prediction. In some implementations, the first block predictions may be directional predictions, and the second block prediction may be a non-directional prediction.

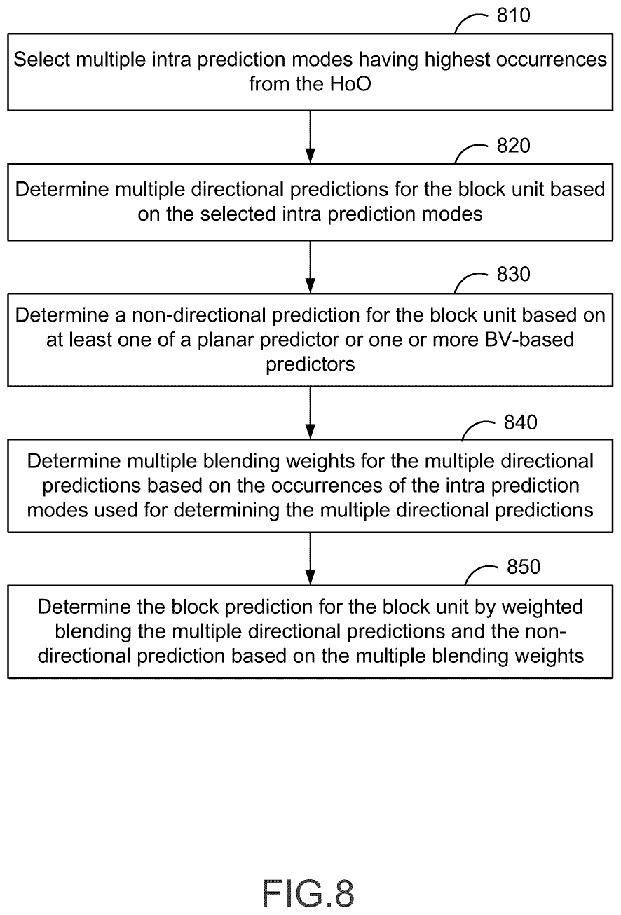

FIG. 8 is a flowchart illustrating a process for determining a block prediction for the block unit based on the HoO, in accordance with one or more example implementations of this disclosure. Each action illustrated in FIG. 8 may represent one or more processes, methods, or subroutines performed by an electronic device. The order in which the actions appear in FIG. 8 is for illustration only, and may not be construed to limit the scope of the present disclosure, thus may be different from what is illustrated. Additional actions may be added, or fewer actions may be utilized, without departing from the scope of the present disclosure.

Referring to FIGS. 3 and 8, in some implementations, action 340 may include actions 810 to 805. In action 810, the decoder module 124/encoder module 114 may select multiple intra prediction modes (e.g., up to 5 intra prediction modes) having highest occurrences from the HoO. In action 820, the decoder module 124/encoder module 114 may determine multiple directional predictions for the block unit based on the selected intra prediction modes. In should be noted that the number of the selected intra prediction modes (e.g., the number of the determined directional predictions) may be predefined, which may not be limited in the present disclosure.

In action 830, the decoder module 124/encoder module 114 may determine a non-directional prediction for the block unit based on at least one of a planar predictor or one or more BV-based predictors.

In some implementations, the decoder module 124/encoder module 114 may determine the planar prediction for the block unit using the planar mode. The non-directional prediction for the block unit may be considered to be the planar predictor.

In some implementations, the decoder module 124/encoder module 114 may determine the one or more BV-based predictors using one or more reconstructions of one or more first reference blocks as described above.

In some implementations, only one first reference block exists. The decoder module 124/encoder module 114 may determine the reconstruction of the first reference block as the BV-based predictor, and consider the non-directional prediction for the block unit to be the BV-based predictor.

In some implementations, multiple first reference blocks exist. The number of the BV-based predictor(s) may be predefined and the one or more first reference blocks used for determining the BV-based predictor(s) may be selected based on template costs (e.g., Sum of Absolute Difference (SAD), Sum of Absolute Transformed Difference (SATD, etc).

For example, for each of the first reference blocks, the decoder module 124/encoder module 114 may determine a template cost based on a first reconstructed template (e.g., a top region, a left region, and/or a top-left region) of the block unit and a second reconstructed template (e.g., a top region, a left region, and/or a top-left region) of the corresponding first reference block. As such, each first reference block may correspond to a template cost. Then, the decoder module 124/encoder module 114 may select a predefined number of first reference blocks corresponding to the smallest template costs and consider the reconstructions of the selected first reference blocks to be the BV-based predictors. The decoder module 124/encoder module 114 may determine the non-directional prediction for the block unit by weighted blending the predefined number of BV-based predictors, where a weight for each BV-based predictor may be determined based on (e.g., positively correlated to) the corresponding template cost.

Referring back to FIG. 8, in action 840, the decoder module 124/encoder module 114 may determine multiple blending weights for the multiple directional predictions based on the occurrences of the intra prediction modes used for determining the multiple directional predictions.

In some implementations, the blending weight of each directional prediction may be positively correlated to the occurrence of the corresponding intra prediction mode in the HoO.

In some implementations, the non-directional prediction may be assigned a predefined blending weight (e.g., wₙₒₙ), and the complement weight (e.g., 1-wₙₒₙ) may be proportionally allocated to the directional predictions based on the occurrence of the corresponding intra prediction modes in the HoO.

In action 850, the decoder module 124/encoder module 114 may determine the block prediction for the block unit by weighted blending the multiple directional predictions and the non-directional prediction based on the multiple blending weights.

In some implementations, once the blending weights for the non-directional prediction and the directional predictions have been determined as described above, the block prediction P(x, y) for the block unit at sample position (x, y) may be generated by a weighted sum of all prediction components. For example, the block prediction P(x, y) may be calculated as:

$$P ( x , y ) = {w}_{n o n} \cdot {P}_{n o n} ( x , y ) + {\sum }_{i} {w}_{i} \cdot {P}_{i} ( x , y ) ,$$

where Pₙₒₙ(x, y) may represent the non-directional prediction, Pᵢ (x, y) may represent the i-th directional prediction, wₙₒₙ may represent the predefined blending weight assigned to the non-directional prediction, wᵢ may represent the blending weight assigned to the i-th directional prediction determined in action 840, and the summation is performed over all directional predictions (i=1, . . . , N, where N may be the number of directional predictions determined in action 820, e.g., up to 5).

Referring back to FIG. 3, in action 350, the method/process 300 may reconstruct the block unit based on the block prediction.

In some implementations, the decoder module 124/encoder module 114 may determine the predicted samples of the block unit (e.g., P(x, y)), then reconstruct the block unit based on the predicted samples. In some implementations, the decoder module 124/encoder module 114 may add multiple residual components to the predicted samples of the block unit to reconstruct the block unit. The residual components may be determined from the bitstream. Once the block unit is reconstructed, the method/process 300 may then end. By repeating the method/process 300, multiple block units may be reconstructed and, as a result, the image frames included in the video data may be reconstructed accordingly.

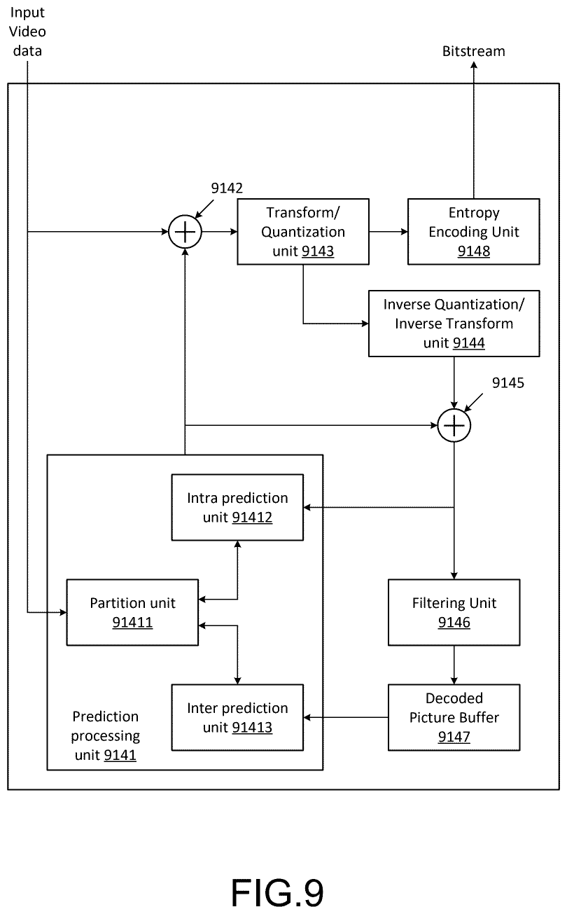

FIG. 9 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 9141), at least a first summer (e.g., a first summer 9142) and a second summer (e.g., a second summer 9145), a transform/quantization processor (e.g., a transform/quantization unit 9143), an inverse quantization/inverse transform processor (e.g., an inverse quantization/inverse transform unit 9144), a filter (e.g., a filtering unit 9146), a decoded picture buffer (e.g., a decoded picture buffer 9147), and an entropy encoder (e.g., an entropy encoding unit 9148). The prediction processing unit 9141 of the encoder module 114 may further include a partition processor (e.g., a partition unit 91411), an intra prediction processor (e.g., an intra prediction unit 91412), and an inter prediction processor (e.g., an inter prediction unit 91413).

The encoder module 114 may receive the source video and encode the source video to output a bitstream. The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 9141 may receive a current image block of a specific one of the image frames. The current image block may be the luminance block or one of the chrominance blocks in the specific image frame.

The partition unit 91411 may divide the current image block into multiple block units. The intra prediction unit 91412 may perform intra-predictive coding of a current block unit relative to one or more neighboring blocks in the same frame as the current block unit in order to provide spatial prediction. The inter prediction unit 91413 may perform inter-predictive coding of the current block unit relative to one or more blocks in one or more reference image blocks to provide temporal prediction.

The prediction processing unit 9141 may select one of the coding results generated by the intra prediction unit 91412 and the inter prediction unit 91413 based on a mode selection method, such as a cost function. The mode selection method may be a rate-distortion optimization (RDO) process.

The prediction processing unit 9141 may determine the selected coding result and provide a predicted block corresponding to the selected coding result to the first summer 9142 for generating a residual block and to the second summer 9145 for reconstructing the encoded block unit. The prediction processing unit 9141 may further provide syntax elements, such as motion vectors, intra-mode indicators, partition information, and/or other syntax information, to the entropy encoding unit 9148.

The intra prediction unit 91412 may intra-predict the current block unit. The intra prediction unit 91412 may determine an intra prediction mode directed toward a reconstructed sample neighboring the current block unit in order to encode the current block unit.

The intra prediction unit 91412 may encode the current block unit using various intra prediction modes. The intra prediction unit 91412 of the prediction processing unit 9141 may select an appropriate intra prediction mode from the selected modes. The intra prediction unit 91412 may encode the current block unit using a cross-component prediction mode to predict one of the two chroma components of the current block unit based on the luma components of the current block unit. The intra prediction unit 91412 may predict a first one of the two chroma components of the current block unit based on the second of the two chroma components of the current block unit.

The inter prediction unit 91413 may inter-predict the current block unit as an alternative to the intra prediction performed by the intra prediction unit 91412. The inter prediction unit 91413 may perform motion estimation to estimate motion of the current block unit for generating a motion vector.

The motion vector may indicate a displacement of the current block unit within the current image block relative to a reference block unit within a reference image block. The inter prediction unit 91413 may receive at least one reference image block stored in the decoded picture buffer 9147 and estimate the motion based on the received reference image blocks to generate the motion vector.

The first summer 9142 may generate the residual block by subtracting the prediction block determined by the prediction processing unit 9141 from the original current block unit. The first summer 9142 may represent the component or components that perform this subtraction.

The transform/quantization unit (143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 9143 may perform a scan of the matrix including the quantized transform coefficients. Alternatively, the entropy encoding unit 9148 may perform the scan.

The entropy encoding unit 9148 may receive multiple syntax elements from the prediction processing unit 9141 and the transform/quantization unit (143, including a quantization parameter, transform data, motion vectors, intra modes, partition information, and/or other syntax information. The entropy encoding unit 9148 may encode the syntax elements into the bitstream.

The entropy encoding unit 9148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 9144 may apply inverse quantization and inverse transformation to reconstruct the residual block in the pixel domain for later use as a reference block. The second summer 9145 may add the reconstructed residual block to the prediction block provided by the prediction processing unit 9141 in order to produce a reconstructed block for storage in the decoded picture buffer 9147.

The filtering unit 9146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 9145.

The decoded picture buffer 9147 may be a reference picture memory that stores the reference block to be used by the encoder module 114 to encode video, such as in intra-coding or inter-coding modes. The decoded picture buffer 9147 may include a variety of memory devices, such as DRAM (e.g., including SDRAM), MRAM, RRAM, or other types of memory devices. The decoded picture buffer 9147 may be on-chip with other components of the encoder module 114 or off-chip relative to those components.

As described above, the method/process 300 for decoding/encoding video data may be performed by the first electronic device 110.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a Histogram of Occurrences (HoO) for the block unit, wherein determining the HoO comprises:
determining one or more first reference blocks based on one or more first block vectors of one or more first neighboring blocks of the block unit,
determining one or more first intra prediction modes based on the one or more first reference blocks, and
constructing the HoO based on the one or more first intra prediction modes;
determine a block prediction for the block unit based on the HoO; and
reconstruct the block unit based on the block prediction.

2. The electronic device of claim 1, wherein determining the HoO further comprises:
determining an intra prediction mode of a first reference block among the one or more first reference blocks; and
updating the HoO by accumulating a weighted occurrence of the intra prediction mode,
wherein the intra prediction mode of the first reference block corresponds to a weight, and the weight is determined based on an area of the first reference block.

3. The electronic device of claim 1, wherein determining the HoO further comprises:
determining an intra prediction mode of a first reference block among the one or more first reference blocks; and
updating the HoO by accumulating a weighted occurrence of the intra prediction mode,
wherein the intra prediction mode of the first reference block corresponds to a weight, and the weight is determined based on a distance between the block unit and the first reference block.

4. The electronic device of claim 1, wherein determining the one or more first reference blocks based on the one or more first block vectors of the one or more first neighboring blocks of the block unit comprises:
determining one or more second reference blocks indicated by the one or more first block vectors;
determining one or more second block vectors of the one or more second reference blocks; and
determining the one or more first reference blocks based on the one or more second block vectors.

5. The electronic device of claim 1, wherein determining the one or more first intra prediction modes based on the one or more first reference blocks comprises:
determining that a first reference block, among the one or more first reference blocks, is coded based on a Virtual Intra Prediction Mode (VIPM); and
applying a Decoded-side Intra Prediction Mode Derivation (DIMD) on the first reference block to derive at least one second intra prediction mode, among the one or more first intra prediction modes.

6. The electronic device of claim 1, wherein the one or more first intra prediction modes comprises a plurality of first intra prediction modes, and determining the one or more first intra prediction modes based on the one or more first reference blocks comprises:
determining a plurality of of selected first reference blocks, among the one or more first reference blocks, based on a plurality of of distances from the block unit to the plurality of selected first reference blocks; and
determining the plurality of first intra prediction modes of the plurality of selected first reference blocks,
wherein a total number of the plurality of first intra prediction modes is equal to a predetermined number.

7. The electronic device of claim 1, wherein determining the HoO further comprises:
determining a temporal candidate associated with the block unit, the temporal candidate being collocated with the block unit;
determining at least one temporal-shifted candidate, that is associated with the block unit, based on at least one motion vector of at least one second neighboring block of the block unit;
determining a plurality of third intra prediction modes based on the temporal candidate and the at least one temporal-shifted candidate; and
constructing the HoO further based on the plurality of third intra prediction modes.

8. The electronic device of claim 7, wherein determining the HoO further comprises:
determining whether at least one candidate, among the temporal candidate and the at least one temporal-shifted candidate, corresponds to at least one third block vector; and
when the at least one candidate is determined to correspond to the at least one third block vector:
determining at least one third reference block based on the at least one third vector,
determining one or more fourth intra prediction modes based on the at least one third reference block, and
constructing the HoO further based on the one or more fourth intra prediction modes.

9. The electronic device of claim 1, wherein determining the block prediction for the block unit based on the HoO comprises:
selecting, from the HoO, a plurality of intra prediction mode having highest occurrences;
determining a plurality of directional predictions based on the selected plurality of intra prediction modes;
determining a non-directional prediction based on at least one of a planar predictor or one or more block vector-based predictors;
determining a plurality of blending weights for the plurality of directional predictions based on a plurality of occurrence amplitudes of the selected plurality of intra prediction modes; and
determining the block prediction by weighted blending the plurality of directional predictions and the non-directional prediction based on the plurality of blending weights.

10. The electronic device of claim 9, wherein the one or more first reference blocks comprise a plurality of first reference blocks, and determining the block prediction for the block unit based on the HoO further comprises:
determining a plurality of template costs for the plurality of first reference blocks, wherein determining the plurality of template costs comprises:
for each of the plurality of first reference blocks, determining one of the plurality of template costs based on a first reconstructed template of the block unit and a second reconstructed template of a corresponding first reference block;
selecting a plurality of block vector-based predictors corresponding to the plurality of first reference blocks based on the plurality of template costs; and
determining the non-directional prediction by weighted blending the selected plurality of block vector-based predictors, a weight for each of the selected plurality of block vector-based predictors being determined based on the plurality of template costs.

11. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a Histogram of Occurrences (HoO) for the block unit, wherein determining the HoO comprises:
determining one or more first reference blocks based on one or more first block vectors of one or more first neighboring blocks of the block unit,
determining one or more first intra prediction modes based on the one or more first reference blocks, and
constructing the HoO based on the one or more first intra prediction modes;
determine a block prediction for the block unit based on the HoO; and
reconstruct the block unit based on the block prediction.

12. The electronic device of claim 11, wherein determining the HoO further comprises:
determining an intra prediction mode of a first reference block among the one or more first reference blocks; and
updating the HoO by accumulating a weighted occurrence of the intra prediction mode,
wherein the intra prediction mode of the first reference block corresponds to a weight, and the weight is determined based on at least one of an area of the first reference block or a distance between the block unit and the first reference block.

13. The electronic device of claim 11, wherein determining the one or more first reference blocks based on the one or more first block vectors of the one or more first neighboring blocks of the block unit comprises:
determining one or more second reference blocks indicated by the one or more first block vectors;
determining one or more second block vectors of the one or more second reference blocks; and
determining the one or more first reference blocks based on the one or more second block vectors.

14. The electronic device of claim 11, wherein determining the one or more first intra prediction modes based on the one or more first reference blocks comprises:
determining that a first reference block, among the one or more first reference blocks, is coded based on a Virtual Intra Prediction Mode (VIPM); and
applying a Decoded-side Intra Prediction Mode Derivation (DIMD) on the first reference block to derive at least one second intra prediction mode, among the one or more first intra prediction modes.

15. The electronic device of claim 11, wherein the one or more first intra prediction modes comprises a plurality of first intra prediction modes, and determining the one or more first intra prediction modes based on the one or more first reference blocks comprises:
determining a plurality of selected first reference blocks, among the one or more first reference blocks, based on a plurality of distances from the block unit to the plurality of selected first reference blocks; and
determining the plurality of first intra prediction modes of the plurality of selected first reference blocks,
wherein a total number of the plurality of first intra prediction modes is equal to a predetermined number.

16. The electronic device of claim 11, wherein determining the HoO further comprises:
determining a temporal candidate associated with the block unit, the temporal candidate being collocated with the block unit;
determining at least one temporal-shifted candidate, that is associated with the block unit, based on at least one motion vector of at least one second neighboring block of the block unit;
determining a plurality of third intra prediction modes based on the temporal candidate and the at least one temporal-shifted candidate; and
constructing the HoO further based on the plurality of third intra prediction modes.

17. The electronic device of claim 16, wherein constructing the HoO further comprises:
determining whether at least one candidate, among the temporal candidate and the at least one temporal-shifted candidate, corresponds to at least one third block vector; and
when the at least one candidate is determined to correspond to the at least one third block vector:
determining at least one third reference block based on the at least one third vector,
determining one or more fourth intra prediction modes based on the at least one third reference block, and
constructing the HoO further based on the one or more fourth intra prediction modes.

18. The electronic device of claim 11, wherein determining the block prediction for the block unit based on the HoO comprises:
selecting, from the HoO, a plurality of intra prediction mode having highest occurrences;
determining a plurality of directional predictions based on the selected plurality of intra prediction modes;
determining a non-directional prediction based on at least one of a planar predictor or one or more block vector-based predictors;
determining a plurality of blending weights for the plurality of directional predictions based on a plurality of occurrence amplitudes of the selected plurality of intra prediction modes; and
determining the block prediction by weighted blending the plurality of directional predictions and the non-directional prediction based on the plurality of blending weights.

19. The electronic device of claim 18, wherein the one or more first reference blocks comprise a plurality of first reference blocks, and determining the block prediction for the block unit based on the HoO further comprises:
determining a plurality of template costs for the plurality of first reference blocks, wherein determining the plurality of template costs comprises:
for each of the plurality of first reference blocks, determining one of the plurality of template costs based on a first reconstructed template of the block unit and a second reconstructed template of the corresponding first reference block;
selecting a plurality of block vector-based predictors corresponding to the plurality of first reference blocks based on the plurality of template costs; and
determining the non-directional prediction by weighted blending the selected plurality of block vector-based predictors, a weight for each of the selected plurality of block vector-based predictors being determined based on the plurality of template costs.

20. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from an image frame retrieved from the video data;
determine a Histogram of Occurrences (HoO) for the block unit, wherein determining the HoO comprises:
determining one or more first reference blocks based on one or more first block vectors of one or more first neighboring blocks of the block unit;
determining one or more first intra prediction modes based on the one or more first reference blocks; and
constructing the HoO based on the one or more first intra prediction modes;
determine a block prediction for the block unit based on the HoO; and
reconstruct the block unit based on the block prediction.
